(19) United States
(12) Patent Application Publication
(10) Pub. No.: US 2008/0094822 A1
(43) Pub. Date: Apr. 24, 2008

(54) Traffic stick

(76) Inventor: Jung-Lang Hsu, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/583,013

(22) Filed: Oct. 19, 2006

(51) Int. Cl. A45B 3/02; F21L 4/02

(52) U.S. Cl. 362/102; 362/184; 362/186

(57) ABSTRACT

A traffic stick, which houses a battery, a circuit board, a set of LEDs, a siren, and two switches such that the switches are operable to drive the LEDs to emit light and the siren to make a loud piercing sound.

### BACKGROUND OF THE INVENTION

1. Field of the Invention

The present invention relates to traffic sticks and more particularly, to such a traffic stick that is operable to produce sound and light.

2. Description of the Related Art

A conventional traffic stick is a hollow bar that houses a circuit board, a battery, a lamp bulb, and a switch. The user can operate the switch to turn on the lamp bulb. This design of traffic stick can simply produce a visual signal when dark. When guiding the traffic, the traffic policeman may have to use a siren to give a loud piercing sound. While holding the siren in the mouth, the traffic policeman cannot wear a mouth-muffle to prevent infections and will breathe in vehicle exhaust gas.

### SUMMARY OF THE INVENTION

The present invention has been accomplished under the circumstances in view. It is the main object of the present invention to provide a traffic sound, which is operable to give a visual signal as well as an audio signal. To achieve this and other objects of the present invention, the traffic stick houses a battery, a circuit board, a set of LEDs, a siren, and two switches such that the switches are operable to drive the LEDs to emit light and the siren to make a loud piercing sound.

### BRIEF DESCRIPTION OF THE DRAWINGS

FIG. 1 is a perspective view of a traffic stick according to the present invention.

FIG. 2 is a sectional view of the traffic stick according to the present invention.

### DETAILED DESCRIPTION OF THE PREFERRED EMBODIMENT

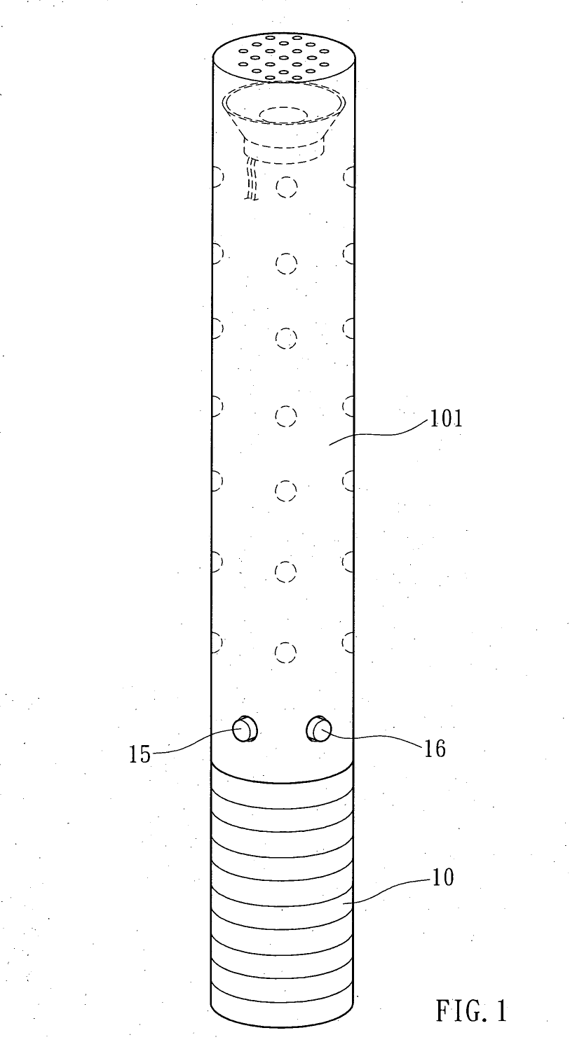

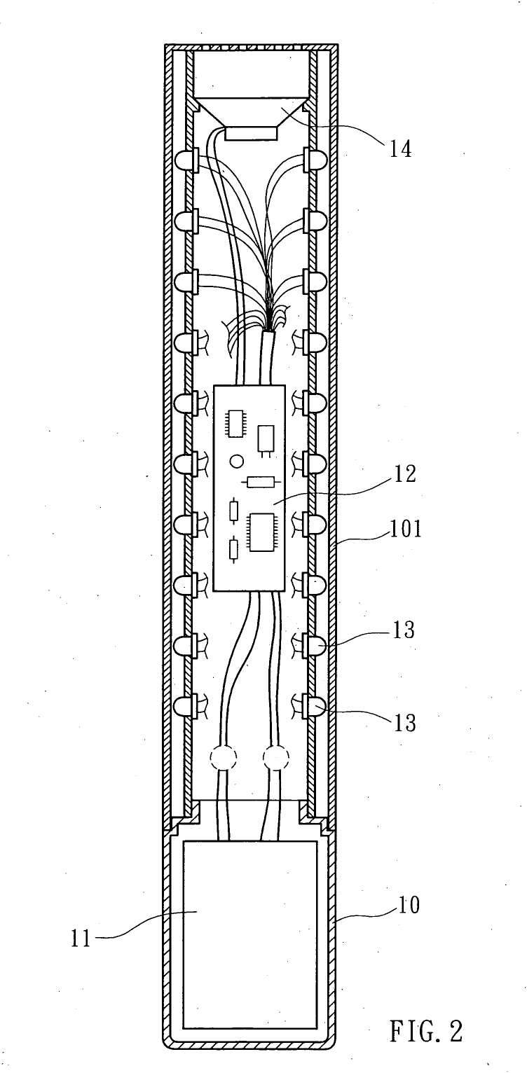

Referring to FIGS. 1 and 2, a traffic stick in accordance with the present invention is shown comprising a hollow elongated transmissive shell 101 and a hollow grip 10 fixedly connected to one end of the shell 101. The shell 101 houses a circuit board 12, a plurality of LEDs (light emitting diodes) 13, and a siren 14. The LEDs 13 and the siren 14 are electrically connected to the circuit board 12 through a first switch 15 and a second switch 16 respectively. The first switch 15 and the second switch 16 are respectively and partially extending out of the outer surface of the shell 101 so that the user can operate the first switch 15 and the second switch 16 to control the operation of the circuit board 12, driving the LEDs 13 to emit light and the siren 14 to make a loud piercing sound. Further, a battery 11 is mounted in the grip 10 and electrically connected to the circuit board 12 to provide the circuit board 12, the driving the LEDs 13 and the siren 14 with the necessary working voltage.

A prototype of traffic stick has been constructed with the features of FIGS. 1 and 2. The traffic stick functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A traffic stick comprising:
a hollow elongated transmissive shell;
a hollow grip fixedly connected to one end of said hollow elongated transmissive shell;
a circuit board fixedly mounted inside said hollow elongated transmissive shell;
a plurality of light emitting diodes arranged inside said hollow elongated transmissive shell and electrically connected to said circuit board;
a battery mounted inside said hollow grip and electrically connected to said circuit board; and
switch means mounted in said electrically connected to said circuit board near said hollow grip and operable to control the operation of said circuit board and to drive said light emitting diodes to emit light;
wherein a siren is mounted inside said hollow elongated transmissive shell and electrically connected to said circuit board and said switch means and controllable by said switch means to make a loud piercing sound
